(19) United States
(12) Patent Application Publication
(10) Pub. No.: US 2026/0359537 A1
(43) Pub. Date: Nov. 12, 2026

(54) DETERMINATION OF DESIGN CONSTRAINTS FOR THE PHYSICAL DESIGN OF INTEGRATED CIRCUITS

(71) Applicant: INTERNATIONAL BUSINESS MACHINES CORPORATION, ARMONK, NY (US)

(72) Inventors: Julian Stefanac, Bargfeld-Stegen (DE); Eduard Herkel, Stuttgart (DE); Alexander Laichinger, Ebersbach an der Fils (DE); Florian Braun, Albbruck (DE); Manuel Beck, Dettingen unter Teck (DE); Markus Kaltenbach, Tübingen (DE); Marvin von der Ehe, Vellmar (DE); Martina Feith, Reutlingen (DE); Gabriele Andrea Dauber, Poughkeepsie, NY (US); Claudia Lütz, Sindelfingen (DE)

(21) Appl. No.: 19/567,543

(22) Filed: Mar. 16, 2026

(30) Foreign Application Priority Data
May 8, 2025 (GB) 2507019.4

(51) Int. Cl. G06F 30/337; G06F 30/323; G06F 30/3308; G06F 30/392; G06F 30/394; G06F 111/04; G06F 111/20; G06F 119/12

(52) U.S. Cl. CPC G06F 30/337; G06F 30/323; G06F 30/3308; G06F 30/392; G06F 30/394; G06F 2111/04; G06F 2111/20; G06F 2119/12

(57) ABSTRACT

Disclosed herein is a method of integrated circuit manufacturing using an Electronic Design Automation system to ultimately generate an integrated circuit. In one embodiment, this comprises receiving a critical signal path of an overall logic design of the integrated circuit. A preliminary physical design of the critical signal path is then generated using a library of existing logic design files. The existing logic design files comprises physical placement descriptors. Furthermore, the preliminary physical design comprises a preliminary physical layout of the critical signal path, preliminary physical placement descriptors, and a set of design constraints of the overall logic design of the integrated circuit. The method further comprises providing the design constraints of the overall logic design of the integrated circuit.

### BACKGROUND

The present invention relates to the automated design of physical designs for integrated circuits, in particular to the design of critical signal paths of an overall logic design of the integrated circuit.

The physical design of integrated circuits (ICs) is the process of transforming a circuit's logical representation into a physical layout that can be fabricated. This involves partitioning, placement, routing, and optimization to meet performance, power, timing, and other constraints. A key challenge in this process is managing critical signal paths, which are portions of the design where timing constraints must be met to ensure correct operation. These paths dictate the maximum clock frequency and can limit overall performance, as delays in these regions may lead to timing violations. Addressing these constraints requires careful placement and routing strategies to minimize delay and signal integrity issues.

### SUMMARY

In one aspect a method of integrated circuit manufacturing using an Electronic Design Automation system to design an integrated circuit is disclosed. The method comprises receiving a critical signal path of an overall logic design of the integrated circuit. The method further comprises generating a preliminary physical design of the critical signal path using a library of existing logic design files. The existing logic design files comprise physical placement descriptors. The preliminary physical design comprises a preliminary physical layout of the critical signal path, preliminary physical placement descriptors, and a set of design constraints of the overall logic design of the integrated circuit. The method further comprises providing the design constraints of the overall logic design of the integrated circuit.

In another aspect, a computer program product comprising a computer-readable storage medium and having a computer-readable program code embodied therewith is disclosed. The computer-readable program code is configured to implement an example of the method.

In another example, a computer system is disclosed. The computer system comprises a processor configured for controlling said Electronic Design Automation system. The computer system further comprises a memory storing computer-readable program code for implementing an Electronic Design Automation system. The execution of said computer-readable program code causes the processor to receive a critical signal path of the overall logic design of the integrated circuit.

Further execution of said computer-readable program code causes said processor to generate a preliminary physical design of the critical signal path using a library of existing logic design files. The existing logic design files comprise physical placement descriptors. The physical design comprises a preliminary physical layout of the physical signal path, preliminary physical placement descriptors, and a set of design constraints of the overall logic design of the integrated circuit. The execution of the computer-readable program code further causes the processor to provide the design constraints of the overall logic design of the integrated circuit.

### BRIEF DESCRIPTION OF THE DRAWINGS

In the following embodiments of the invention are explained in greater detail, by way of example only, making reference to the drawings in which:

FIG. 1 illustrates an example of a computing environment.

FIG. 2 depicts a cloud computing environment according to an example of the present invention.

FIG. 3 depicts an abstraction model layers according to an example of the present invention.

FIG. 4 shows a further view of the computing environment.

FIG. 5 illustrates a method of using the computing environment of FIG. 4.

FIG. 6 shows a further view of the computing environment.

FIG. 7 illustrates a method of using the computing environment of FIG. 6.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In one aspect, a method of integrated circuit manufacturing using an Electronic Design Automation system to design an integrated circuit is disclosed. An Electronic Design Automation system encompasses a software tool or set of specialized software tools that enable the creation, design optimization, and verification of the physical layout of an integrated circuit. The physical layout of an integrated circuit encompasses the actual physical design of the integrated circuit and enables manufacturing of the integrated circuit.

The method comprises receiving a critical signal path of a logic design of the integrated circuit. The logic design of the integrated circuit encompasses the functional design of the integrated circuit but does not specify the physical layout of the integrated circuit. The physical layout is provided by the Electronic Design Automation system. A critical signal path is a portion of the design of the integrated circuit which sets a timing constraint for the design of the integrated circuit. This may encompass such things as components which may cause a delay or for which timing is critical. The critical signal path of the overall logic design is important because it can determine the maximum rate or clock rate which the integrated circuit can be run at.

The method further comprises generating a preliminary physical design of the critical signal path using a library of existing logic design files. The library of existing logic design files may for example be logic design files which were converted into successful physical integrated circuit designs. In this case, there then exists a body of realistic physical components which can be drawn upon. The existing logic design files comprise physical placement descriptors. The physical placement descriptors comprise a description of how the various components or layers of the integrated circuit are positioned. The preliminary physical design comprises a preliminary physical layout of the critical signal path, preliminary physical placement descriptors, and a set of design constraints of the overall logic design of the integrated circuit.

When creating a new physical design of an integrated circuit, the critical signal paths can be a limitation. However, correctly determining design constraints based on the critical signal path may be difficult due to the large amount of time which is required for an Electronic Design Automation system to provide a fully functional design of the entire integrated circuit. In such cases it may not be realistic to repeatedly model the overall logic design to determine design constraints. The set of design constraints are constructed or determined by looking at only the critical signal path. Since the critical signal path may be a reduced portion or set of the design of the overall logic design of the integrated circuit it may run orders of magnitude more quickly. The generation of the physical design can therefore be produced over and over again and a set of realistic design constraints as well as the other physical layout of the critical signal path and the preliminary physical placement descriptors can be determined accurately.

The method further comprises providing the design constraints of the overall logic design of the integrated circuit. The design constraints may, for example, be used to configure or control the Electronic Design Automation system. These design constraints therefore have a technical effect and enable the correct generation of a physical integrated circuit design from the overall logic design of the integrated circuit. This example may be beneficial because it may provide for an accelerated means of generating a physical design of an integrated circuit using an Electronic Design Automation system.

In another example, the one or more synthesis steps are disabled in the Electronic Design Automation system when generating the preliminary physical design of the critical signal path. Because the preliminary physical design of the critical signal path is only for the critical signal path and not for the entire integrated circuit, various synthesis steps are not needed. This may have the effect of greatly accelerating the generation of the preliminary physical design and the determination of the set of design constraints. Since the computational time may be greatly reduced, this may enable the set of design constraints to be determined more accurately.

In another example, the disabled synthesis steps comprise disabling the generation of place fill. The generation of place fill in an integrated circuit encompasses inserting non-functional or dummy shapes or patterns into an integrated circuit's layout to improve such things as manufacturability, better thermal stress, and design rule compliance. As the critical signal path is not intended to be manufacture the preliminary physical design, it is not necessary to generate place fill, and this greatly accelerates the determination of the set of design constraints.

In another example, the disabled synthesis steps comprise at least partially disabling the inclusion of design-for-testability structures. As the critical signal path is modeled by the Electronic Design Automation system purely for the purpose of determining the design constraints and the preliminary physical layout, it is not necessary to include the design-for-testability structures. This may further have the benefit of accelerating the process of generating the preliminary physical design.

In another example, the one or more disabled synthesis steps comprise at least partially disabling the inclusion of scan infrastructure. The scan infrastructure is also used for testing of a finished integrated circuit. As the preliminary physical design is not intended to be constructed but only for the determination of the set of design constraints as well as the preliminary physical layout, this is not necessary.

In another example, the one or more disabled synthesis steps further comprise ignoring and/or disabling verification environment synthesis steps. Likewise, again because the preliminary physical design of the critical signal path will not be constructed, these verification environment synthesis steps are completely unnecessary and would only cause the Electronic Design Automation system to execute more slowly.

In another example, the one or more disabled synthesis steps further comprise at least partially ignoring design rule check violations during the generation of the preliminary physical design. Again, as the preliminary physical design of the critical signal path will not be constructed it is not necessary to check design rule check violations. This further accelerates the execution of the Electronic Design Automation system when generating the preliminary physical design.

In another example, the one or more disabled synthesis steps comprise the performance of environmental and/or library checks. As it is not desired to manufacture the preliminary physical design of the critical signal path, it is not necessary to perform these environmental and/or library checks and this thereby further accelerates the generation of the preliminary physical design and allows or enables the better determination of the set of design constraints.

In another example, the one or more disabled synthesis steps comprise the disabling the optimization and bouncing of control signals, building an overall timing requirement, and early mode padding. The disabling of one or more of these synthesis steps also accelerates the generation of the preliminary physical design. In early mode padding you add delays to the signal path so that the timing is correct. During the construction of the critical signal path, one is only worried if the signals are too late for the determination of the set of design constraints, therefore early mode padding is not necessary.

In another example, the one or more disabled synthesis steps further comprise early mode checks, which are whole checks which are not performed, corner optimization, and building a clock infrastructure. Corner optimization is basically factoring in variants due to manufacturing variability. The close timing in all these environments is desired. However, since the preliminary physical design is not intended to be manufactured, the corner optimization is not necessary. Likewise, the clock infrastructure is not needed to generate the preliminary physical design and determine the design constraints.

In another example, the one or more disabled synthesis steps further comprise final sign off, scan-chain implementation and construction of overlay cells. The final sign off may comprise a final checklist where electrical constraints, Resistive Capacitive (RC) delays, electrostatic discharge requirements and Design Rule Checks (DRC) are performed. As the preliminary physical design will not be manufactured but is only constructed for the design constraints, these are not necessary. The scan-chain implementation construction provides part of the infrastructure to bring up a chip and ensure that it is functional. Many or all flip-flops may be connected so you can read its values to test after a clock signal. The overlay cell is basically a layout or showing a listing of layers of all metal. During the construction, the design of the integrated circuit is divided into different views. Essentially the physical layout of an integrated circuit is divided into sub-groups. For all three of these, these are not necessary for the construction of the preliminary physical design and are not necessary to be performed. This further accelerates the calculation of the preliminary physical design.

In another example, the design constraints comprise the preliminary placement information for the critical signal path, the cycle time, a semiconductor manufacturing technology node, transistor performance, transistor delay and/or switching time, transistor driving strength, transistor edge steepness, a selection of a cell library for the semiconductor manufacturing technology node, power usage, placement assumptions for building blocks, blockage locations, and combinations thereof. All of these parameters are useful in determining or designing the overall logic design for the integrated circuit. The critical signal path provides a limitation which can be analyzed in advance of manufacturing or designing the rest of the integrated circuit. All of these constraints may be useful in properly configuring or controlling the Electronic Design Automation system when generating an overall physical design from the logic design of the integrated circuit.

In another example, the preliminary physical design is non-functional. By non-functional this may encompass that there are components or structures which would prevent the preliminary physical design of the critical signal path from being manufactured as a functional integrated circuit. This is reasonable as the preliminary physical design of the critical signal path is intended only for testing and determining the set of design constraints within the context of a model. Making the preliminary physical design of the critical signal path completely functional would only cause the Electronic Design Automation system to execute more slowly.

In another example, wherein any one of the following is selected: the preliminary physical design comprises at least one non-functional clock configuration, the preliminary physical design lacks physical interconnects, the preliminary physical design lacks at least one control signal structure, the preliminary physical design lacks processor components, the preliminary physical design lacks connected memory components, and combinations thereof. These are all structures which could be used to manufacture a functional integrated circuit but are not necessary when generating the preliminary physical design. The lack of inclusion of one or more of these features may for example result in a preliminary physical design which is non-functional.

In another example, the at least one control signal structure comprises any one of the following: a hardwired control logic, clocking and synchronization circuits, bus arbitration and control logic, interrupt handling and prioritization circuits, pipeline control and hazard handling circuits, memory management and access control circuits, and combinations thereof. These are all examples of control signal structures which may not be needed when generating the preliminary physical design of the critical signal path. Having these as non-functional may accelerate the Electronic Design Automation system when generating the preliminary physical design and determining the design constraints.

In another example, the critical signal path comprises device building blocks. The device building blocks, as used herein, encompass functional components or groups of components or structures which are used to form circuit components in the integrated circuit. For example, the device building blocks may be assembled into the critical signal path or, in the broader context, used to provide the physical design of the integrated circuit. The device building blocks comprise the physical placement descriptors. The method further comprises flattening the device building blocks before generating the preliminary physical design. For example, the device building blocks may provide sub-building blocks, and they may also be formed from other sub-building blocks. In this way, more complex structures are built up from a collection of less complex structures. During generation of the preliminary physical design, however the device building blocks, and their sub-building blocks are flattened or reconstructed into the actual structures. This for example may be useful in more accurately determining the design constraints.

In another example, the method further comprises checking if the preliminary physical placement descriptors fulfill requirements for simulation of the specified critical signal path. In the generation of the preliminary physical design, a large number of features or synthesis steps for generating the overall integrated circuit may be ignored or dropped off. However, the structures for simulation of the specified critical signal path are useful because then they can be used test if the critical signal path meets timing requirements and thereby use this as a measure to help determine the set of design constraints.

In another example, the preliminary physical design is generated iteratively to determine the set of design constraints. The set of design constraints may for example be settings which are used for the Electronic Design Automation system. Various settings can be tried when generating the preliminary physical design repeatedly. The settings which work can then be considered to be constraints which could be used by the Electronic Design Automation system to successfully create a physical design of the overall integrated circuit.

In another example, the method further comprises receiving the overall logic design of the integrated circuit. The overall logic design of the integrated circuit is the complete logic design. This step may be beneficial because it may enable the use of the Electronic Design Automation system that generates the preliminary physical design to determine the design constraints to generate a physical design for the integrated circuit.

In another example, the method further comprises generating a netlist based on the overall logic design file of the integrated circuit. A netlist as used herein encompasses the detailed list of the components in an electrical or integrated circuit and the connections or nets between them, hence the name netlist. The netlist may be used as a blueprint for not only simulation of the integrated circuit, but also for assembling or creating a physical design of the integrated circuit. Generating the netlist based on the overall logic design file of the integrated circuit may be beneficial because it may enable the simulation and generation of a physical design for the integrated circuit.

In another example, the method further comprises receiving a source and a sink in the overall logic design for the critical signal path. The method further comprises extracting the critical signal path from the overall logic design using the source and the sink. This may provide a means of automatically determining the portion of the netlist necessary for generating the preliminary physical design of the critical signal path. One way of performing this would be to take the netlist and then trace the route between the source and the sink working forwards and backwards to extract the critical signal path.

In another example, the method further comprises generating a physical integrated circuit design with the Electronic Design Automation system using the overall logic design and the design constraints as inputs. The overall logic design can be input for designing the physical layout of the integrated circuit with the Electronic Design Automation system and the design constraints may for example be used for configuring the various software components of the Electronic Design Automation system. This may be particularly advantageous because the design constraints were determined ahead of time when generating the preliminary physical design. As was mentioned above the design constraints may include preliminary placement information for the critical signal path, cycle time, a semiconductor manufacturing technology node, transistor performance, transistor delay and/or switching time, transistor driving strength, transistor edge steepness, selection of a cell library for the semiconductor manufacturing technology node, power usage, placement assumptions for building blocks, blockage locations, and combinations thereof. Determining the design constrains using the preliminary physical design means that the critical signal path will likely function properly when the Electronic Design Automation system is used to generate the physical integrated circuit design. This may be performed with a fewer number of iterations than would normally be performed and may also result in a higher quality or better functioning design.

In another example the preliminary physical layout of the critical signal path is further used as input to the Electronic Design Automation system for generation of the physical integrated circuit design. For example, the preliminary physical layout of the critical signal path may be used as an initial layout of this portion of the overall logic design and may cause the Electronic Design Automation system to converge to a solution more rapidly.

In another example, the method further comprises manufacturing an integrated circuit using the physical integrated circuit design. The physical integrated circuit design specifies the location and position of various layers and materials within the integrated circuit. The physical integrated circuit design may for example be used for making masks for photolithography during the process of manufacturing an integrated circuit and the physical integrated circuit design may be passed along with these masks to a foundry or semiconductor fabrication site and used to manufacture the integrated circuit.

In another example, the integrated circuit comprises the critical signal path. This of course may be beneficial because if the critical signal path functions properly, then the entire integrated circuit could have timing issues resolved.

In another aspect a computer program product is disclosed. The computer program product comprises a computer-readable storage medium having a computer-readable program code embodied therewith. The computer-readable program code is configured to implement an example of the method as described above. This may be beneficial because in the various examples the preliminary physical design of the critical signal path is generated and is used to generate the set of design constraints. This may provide for more rapid development of the integrated circuit as well as providing for a better and more robust design.

In another example, the invention provides for a computer system. The computer system comprises a processor configured for controlling the computer system and a memory. The memory stores computer-readable program code for implementing an Electronic Design Automation system. The execution of the computer-readable program code causes the processor to receive a critical signal path of a logic design of the integrated circuit. The execution of the computer-readable program code further causes the processor to generate a preliminary physical design of the critical signal path using a library of existing logic design files. The existing logic design files comprise physical placement descriptors. The preliminary physical design comprises a preliminary physical layout of the critical signal path, preliminary physical placement descriptors, and a set of design constraints of the overall logic design of the integrated circuit. Execution of the computer-readable program code further causes the processor to provide the design constraints of the overall logic design of the integrated circuit.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for implementing an Electronic Design Automation system 400. In addition to block 400, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

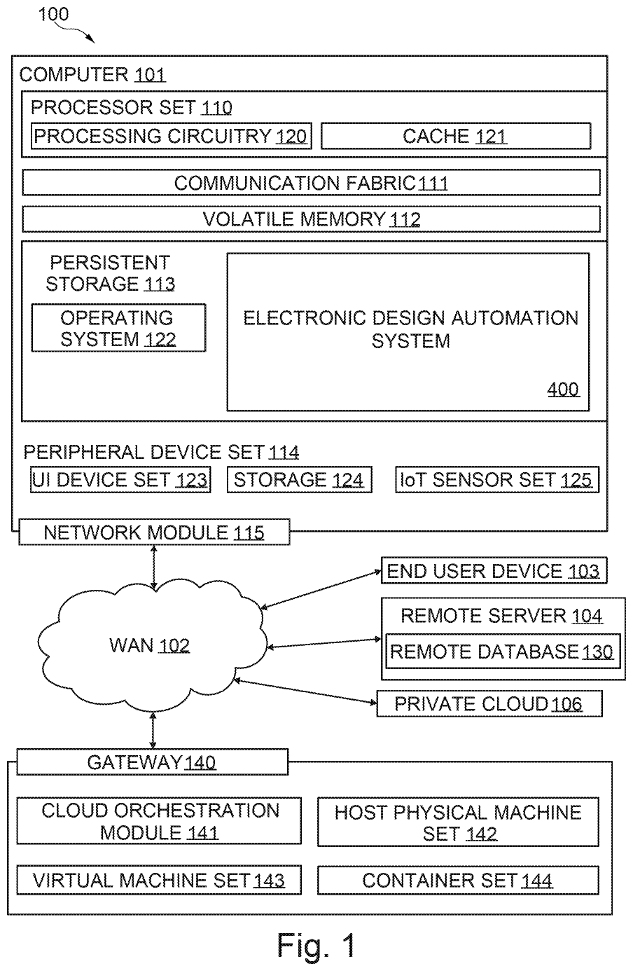

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored with block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included with block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

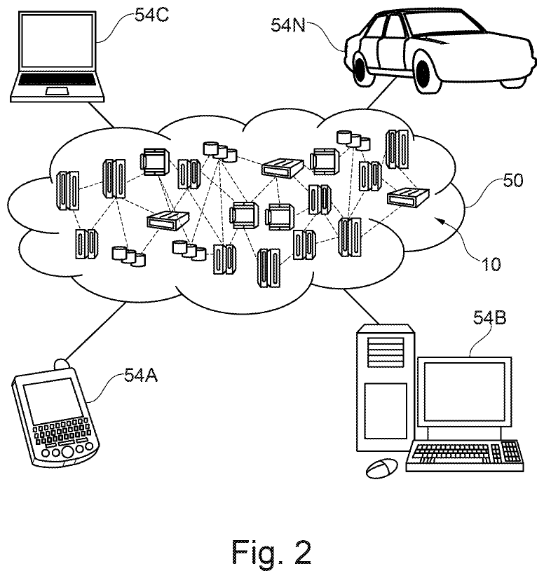

FIG. 2 It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows: On-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service. Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows: Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises. Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds). A cloud computing environment is service oriented with a focus on statelessness, low coupling, modularity, and semantic interoperability. At the heart of cloud computing is an infrastructure that includes a network of interconnected nodes.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

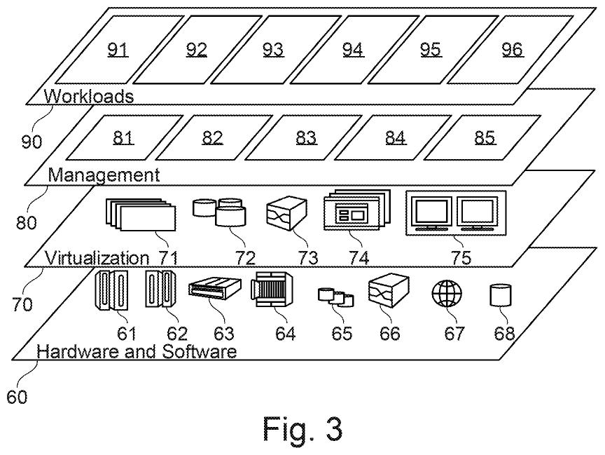

Referring now to FIG. 3, a set of functional abstraction layers provided by cloud computing environment 50 (FIG. 1) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture-based servers 62; servers 63; blade servers 64; storage devices 65; and networking components 66. In some embodiments, software components include network application server software 67 and database software 68. The database software 68 may for example be used to implement the source database and the target database as described above.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the implementation of a target database system 96 that uses an Electronic Design Automation system 400 as was described in the context of FIG. 1. In this example the target database system 96 may also provide data analytics processing.

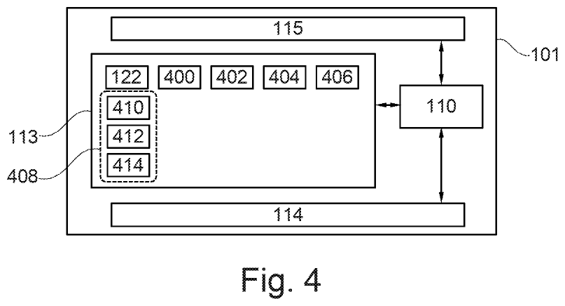

FIG. 4 illustrates a further view of the computer 101. Not all of the components of the computing environment 100 illustrated in FIG. 1 are illustrated in FIG. 4. The memory 113 is further shown as storing the operating system 122 and a logic design of a critical signal path 402 that was extracted from the overall logic design 404. For example, the integrated circuit design 404 could be presented as a netlist and the critical signal path 402 may be a subset of this netlist. The memory 113 is further shown as containing a library of existing logic design files 406. These could be complete physical designs for other integrated circuits. The various components of the existing logic design files may be extracted and then used for construction of the preliminary physical design. The memory 113 is further shown as containing a preliminary physical design 408 that was generated using the critical signal path 402 using the library of existing design files 406. A benefit of using this library is that the preliminary physical design 408 of the critical signal path 402 is assembled using physical structures used in previous integrated circuit designs. The preliminary physical design 408 therefore will resemble similar critical signal paths in these previous integrated circuit designs. The preliminary physical design 408 is shown as comprising a preliminary physical layout 410 of the critical signal path 402, preliminary physical placement descriptors 412, and a set of design constraints 414.

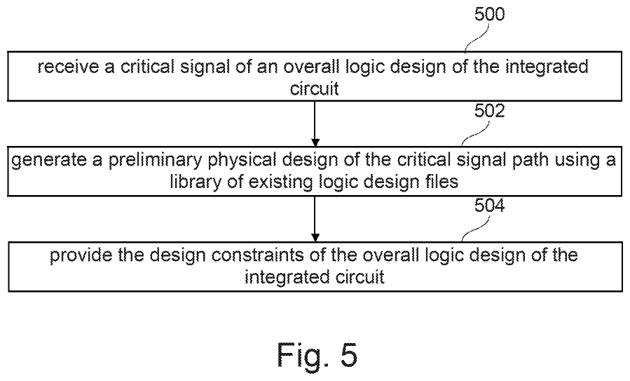

FIG. 5 shows a flowchart which illustrates a method of operating the computer system 101. It uses the implementation of the Electronic Design Automation system 400. In step 500, the critical signal path 402 is received. The critical signal path is a subset of the overall logic design of the integrated circuit. In step 502, the preliminary physical design 408 is generated using the library of existing logic design files 406 and the critical signal path 402. Finally, in step 504, the set of design constraints of the overall logic design 404 are provided. This may be provided in a variety of ways. In one instance the design constraints may be provided by storing them for future use in configuring the Electronic Design Automation system 400. In other cases, this may be used directly for controlling the Electronic Design Automation system to generate a physical design for the overall logic design of the IC.

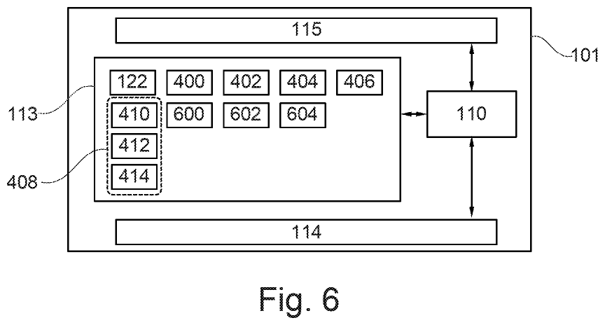

FIG. 6 illustrates a further example of the computer 101. The example illustrated in FIG. 6 is similar to the exemplary computer 101 in FIG. 4 but contains additional features. In this example the memory 113 is shown as further storing a source for the critical signal path 600 and a sink 602 for the critical signal path. This may be used for extracting the critical signal path 402 from the overall logic design 404. The memory 113 is further shown as containing a physical integrated circuit design 604 that was generated using the overall logic design 404 as an input to the Electronic Design Automation system 400. The design constraints 414 and possibly the preliminary physical layout 410 were used as constraints over initial conditions for the Electronic Design Automation system 400.

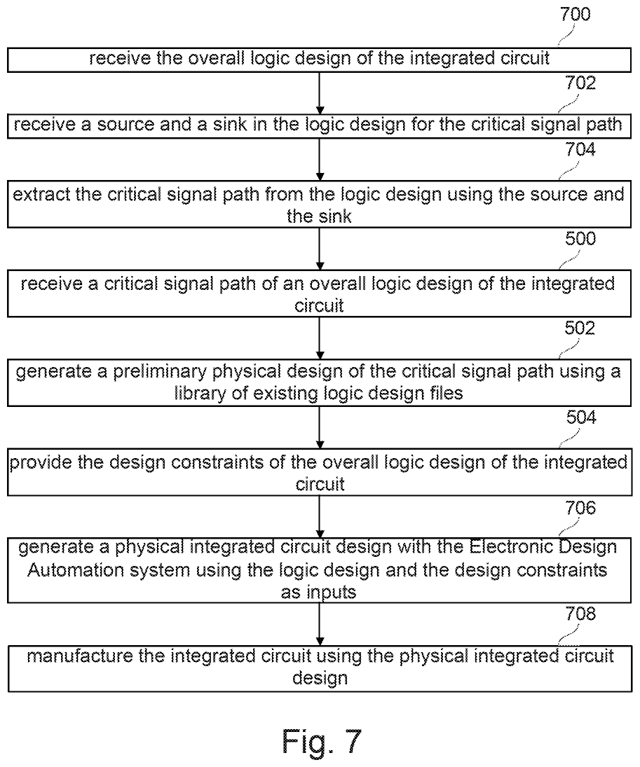

FIG. 7 shows a flowchart which illustrates a method of using the Electronic Design Automation system 400 to manufacture an integrated circuit from the overall logic design 404. In step 700, the method comprises receiving the overall logic design 404 of the integrated circuit. In step 702, the source 600 and the sink 602 in the overall logic design 404 for the critical signal path 402 is received. In step 704, the critical signal path 402 is extracted from the overall logic design 404. Steps 500, 502, and 504 are then performed as was illustrated in FIG. 5. In step 706, the physical integrated circuit design 604 is generated with the Electronic Design Automation system 400 using the overall logic design 404 and the design constraints 414 as inputs. In some cases, the preliminary physical layout 410 may also be used as an input. In step 708, the integrated circuit is manufactured using the physical integrated circuit design 604.

What is claimed is:

1. A method of integrated circuit manufacturing using an Electronic Design Automation system to design an integrated circuit, the method comprising:
receiving a critical signal path of an overall logic design of the integrated circuit;
generating a preliminary physical design of the critical signal path using a library of existing logic design files, wherein the existing logic design files comprises physical placement descriptors, wherein the preliminary physical design comprises a preliminary physical layout of the critical signal path, preliminary physical placement descriptors and a set of design constraints of the overall logic design of the integrated circuit; and
providing the design constraints of the overall logic design of the integrated circuit.

2. The method of claim 1, wherein one or more synthesis steps are disabled in the Electronic Design Automation system when generating the preliminary physical design of the critical signal path.

3. The method of claim 2, wherein the one or more disabled synthesis steps having at least one of a group comprising:
disabling the generation of place fill, at least partially disabling an inclusion of design-for-testability structures, at least partially disabling the inclusion of scan infrastructure, ignoring, or disabling verification environment synthesis steps, at least partially ignoring design rule check violations during the generation of the preliminary physical design, and combinations thereof.

4. The method of claim 2, wherein the one or more disabled synthesis steps having at least one of a group comprising:
performance of environment and/or library checks, optimization and balancing of control signals, building an overall timing requirement, early mode padding, early mode checks (hold checks are not done), corner optimization, building a clock infrastructure, final signoff, scan-chain implementation, construction of overlay cells, and combinations thereof.

5. The method of claim 4, wherein the design constraints comprises at least one of following:
preliminary placement information for the critical signal path, cycle time, a semiconductor manufacturing technology node, transistor performance, transistor delay and/or switching time, transistor driving strength, transistor edge steepness, selection of a cell library for the semiconductor manufacturing technology node, power usage, placement assumptions for building blocks, blockage locations, and combinations thereof.

6. The method of claim 1, wherein the preliminary physical design is non-functional.

7. The method of claim 1, having at least one of a group comprising:
preliminary physical design comprises at least one non-functional clock configuration, the preliminary physical design lacks physical interconnects, the preliminary physical design lacks at least one control signal structure, the preliminary physical design lacks processor components, the preliminary physical design lacks connected memory components, and combinations thereof.

8. The method of claim 1, wherein control signal structure comprises at least one of: Hardwired Control Logic, Clocking and Synchronization Circuits, Bus Arbitration and Control Logic, Interrupt Handling and Prioritization circuits, Pipeline Control and Hazard Handling circuits, Memory Management and Access Control circuits, and combinations thereof.

9. The method of claim 1, wherein the critical signal path comprises device building blocks, wherein the device building blocks comprise physical placement descriptors, further comprising: flattening the device building blocks before generating the preliminary physical design.

10. The method of claim 1, wherein the method further comprises checking if the preliminary physical placement descriptors fulfill requirements for simulation of a specified critical signal path.

11. The method of claim 1, wherein the preliminary physical design is generated iteratively to determine the set of design constraints.

12. The method of claim 1, wherein the method further comprises receiving the overall logic design of the integrated circuit.

13. The method of claim 12, wherein the method further comprises generating a netlist based on the overall logic design file of the integrated circuit.

14. The method of claim 13, wherein the method further comprises:
receiving a source and a sink in the overall logic design for the critical signal path; and
extracting the critical signal path from the overall logic design using the source and the sink.

15. The method of claim 14 wherein the method further comprises generating a physical integrated circuit design with the Electronic Design Automation system using the overall logic design and the design constraints as inputs.

16. The method of claim 15, wherein the preliminary physical layout of the critical signal path is further used as input to the Electronic Design Automation system for generation of the physical integrated circuit design.

17. A computer system comprising:
a processor configured for controlling said computer system; and
a memory storing machine executable instructions for implementing an Electronic Design Automation system, execution of said instructions causes said processor to:
receive a critical signal path of an overall logic design of an integrated circuit;
generate a preliminary physical design of the critical signal path using a library of existing logic design files, wherein the existing logic design files comprise physical placement descriptors, wherein the preliminary physical design comprises a preliminary physical layout of the critical signal path, preliminary physical placement descriptors and a set of design constraints of the overall logic design of the integrated circuit; and
provide the design constraints of the overall logic design of the integrated circuit.

18. The system of claim 17, wherein one or more synthesis steps are disabled in the Electronic Design Automation system when generating the preliminary physical design of the critical signal path.

19. A computer program product for using an Electronic Design Automation system to design an integrated circuit, the computer program product comprising:
one or more computer readable storage media;
program instructions, stored on at least one of the one or more storage media for execution by at least one or more processors via at least one or more memories, to receive a critical signal path of an overall logic design of the integrated circuit;
program instructions, stored on at least one of the one or more storage media for execution by at least one or more processors via at least one or more memories, to generate a preliminary physical design of the critical signal path using a library of existing logic design files, wherein the existing logic design files comprise physical placement descriptors; and wherein the preliminary physical design comprises a preliminary physical layout of the critical signal path, one or more preliminary physical placement descriptors and a set of design constraints of the overall logic design of the integrated circuit; and
program instructions, stored on at least one of the one or more storage media for execution by at least one or more processors via at least one or more memories, to provide the design constraints of the overall logic design of the integrated circuit.

20. A computer program product of claim 19, wherein one or more synthesis steps are disabled in the Electronic Design Automation system when generating the preliminary physical design of the critical signal path.
